(19) United States
(12) Patent Application Publication
(10) Pub. No.: US 2004/0111343 A1
(43) Pub. Date: Jun. 10, 2004

(54) System and method for merchant account acquisition and approval

(75) Inventors: Lisa Lindvall, New York, NY (US); Gintas P. Balodis, New York, NY (US); Bruce Fraedrich, Glendale, AZ (US); Elizabeth Langwith, New York, NY (US)

Correspondence Address: SNELL & WILMER, ONE ARIZONA CENTER, 400 EAST VAN BUREN, PHOENIX, AZ, 850040001

(73) Assignee: American Express Travel Related Services Company, Inc.

(21) Appl. No.: 10/447,597

(22) Filed: May 29, 2003

Related U.S. Application Data
(60) Provisional application No. 60/430,829, filed on Dec. 4, 2002.

(51) Int. Cl. G06F 17/60

(52) U.S. Cl. 705/35

(57) ABSTRACT

A merchant account acquisition and approval system and method generally includes an online application process for card acceptance. The merchant views, completes and receives a merchant account number and rate in real time. A PIN may be used to identify a particular type of merchant and grant access to a specific set of terms and conditions for card acceptance. The merchant may enter the PIN to view the terms and conditions online prior to acceptance of the card acceptance agreement. Merchants from a similar locale or business, such as a franchisee and government entity, can receive similar prices, terms and conditions.

### CROSS REFERENCE TO RELATED APPLICATIONS

This application claims priority from U.S. Provisional Patent Application Serial No. 60/430,829 filed Dec. 4, 2002 entitled, “System and Method for Merchant Account Approval,” which is hereby incorporated by reference.

### FIELD OF INVENTION

The invention relates generally to a system and method for merchant account acquisition and approval and, more particularly to a real-time processing system and method for acquiring and approving merchants for acceptance of transaction cards at any merchant location.

### BACKGROUND OF THE INVENTION

For many consumers, the most convenient form of payment for purchases of goods and services is with a transaction card (“card”), having a magnetic stripe, an embossed account number, printed unique card identification number (CID) and/or a smart chip. Cardholders may be use a card, for example, to facilitate transactions at various entities (“merchants”), such as service establishments, customer activated terminals and kiosks, automated teller machines (ATM), point of sale (POS), and instances when the physical card is not required, such as purchases over the Internet.

Generally, in order to accept a card, merchants enter into an agreement with a card issuer to accept a brand of cards (e.g., AMERICAN EXPRESS®, VISA®, MasterCard®, DISCOVER CARD®) and agree to a rate of payment to the issuer often called the “discount rate” (e.g., a flat rate or a percentage of each sale). To use a card, the cardmember or cardholder enters into an agreement with a card issuer, establishes a card account with the issuer, and makes payments to that issuer for purchases or cash advances. The card issuer is typically a bank or other financial organization (e.g., American Express®, Bank of America®, Citibank®, MBNA America®, Chase Manhattan Bank®) operating under the regulations of a card issuing association or entity and its name generally appears on the card.

Due to the numerous advantages of card acceptance, “untraditional” merchants, such as dental and medical offices, and utility companies have started accepting cards for payments of billed services. For the cardmember, paying a bill with a card is a fast, easy way to fulfill payment obligations. Merchants are realizing benefits from card acceptance through immediate payment in full (rather than waiting until customers have the cash on hand) and eliminating the risk of bad checks and costly follow-up billing. Of course, card issuers also generally benefit from increased usage by charging cardmembers interest on outstanding balances and receiving payment from the discount rate pursuant to the merchant/issuer agreement.

Government entities are rapidly joining the list of “untraditional” merchants and starting to accept cards for payments. For example, many local, city, county, state and federal government offices are now accepting cards for payments of duplicate driver licenses, identification cards, personalized/specialty license plates, vehicle registration renewals, payment of taxes, fees and many other government-provided or issued goods and services. However, due to the vast number of government entities, it is logistically challenging for card issuers to visit each one to set up card acceptance agreements. Accordingly, many of the smaller government entities are never approached by issuers, so the benefits of card acceptance to the consumer, merchant and issuer are never realized.

The conventional wisdom is for the issuer to employ additional salespeople to target these smaller government entities, but additional employees are a costly solution. Furthermore, even if the smaller government offices are directly solicited by the issuer, ensuring that each of the offices are set up equally and under similar terms and conditions as the remaining offices within the same locale (e.g., city, county or state) is time-consuming, cumbersome, and may unfairly disadvantage an office agreeing to terms (e.g., discount rate) not as favorable as the remaining offices.

Moreover, direct solicitation by the issuer often results in labor-intensive completion of paper or electronic forms that must be returned to an approving authority and reviewed prior to the merchant being able to start accepting cards.

Attempts have been made to solve some of the above problems by providing an application system for merchant card acceptance using the Internet. For instance, U.S. Pat. No. 6,135,349 issued to Zirkel allows the merchant to submit merchant information, such as the business name, address, type of sales, total sales, and banking information via a HyperText Markup Language (HTML) page on the Internet.

The merchant also enters the credit card brand(s) that it wishes to accept from customers as payment. In most cases, the card processing account is with a third-party provider and therefore the application must be sent to the third-party for approval. Zirkel and similar systems may help to eliminate some of the labor needed to establish a merchant account for card acceptance by utilizing an online process, however, the system still requires a separate approving authority prior to merchant account approval.

In addition, these systems fail to provide a substantially fool-proof way to set-up merchants within the same locale with similar terms and conditions.

Accordingly, a system and method for merchant account acquisition and approval that is cost and labor reducing, easily assessable, and can reach every merchant, regardless of their size or locale is needed. In addition, there is a need for a real-time processing system and method to acquire and approve merchants for acceptance and renewal of cards at any merchant location.

### SUMMARY OF THE INVENTION

A merchant online application process which generally includes a merchant account acquisition and approval system and method for card acceptance which facilitates a merchant being able to view an application, complete an application and receive a merchant account number in real time. A PIN may be used to identify a particular type of merchant and grant access to a specific set of terms and conditions for card acceptance. The merchant may enter the PIN to view the terms and conditions online prior to acceptance of the card acceptance agreement. Merchants from a similar locale or business, such as a franchisee and government entity, can receive similar terms and conditions.

The system facilitates acquisition of new merchant accounts and renewal of existing merchant accounts. The system includes an Internet website having a merchant account application, a merchant workstation in communication with the website via the Internet, wherein the merchant workstation includes a display for viewing a merchant account application retrieved from said server and for viewing a conditional statement retrieved from the database, the conditional statement includes a set of default terms or a specific set of terms such that a selection of the conditional statement is dependent upon the type of merchant applying for account approval. The merchant may complete the online merchant account application, the server receives the application from the workstation, the server generates a merchant account number and provides the account number to the workstation via the network in substantially real-time upon receiving the application.

### BRIEF DESCRIPTION OF THE DRAWINGS

Certain features, aspects and advantages of the present invention may be best understood by reference to the following description taken in conjunction with the accompanying drawings, wherein like reference numerals represent like elements:

FIG. 1 illustrates an exemplary system for merchant account acquisition and approval;

FIG. 2 is a flowchart describing various exemplary embodiments of merchant account acquisition and approval in accordance with the invention; and

FIG. 3 is a flowchart describing one particular exemplary embodiment of merchant account acquisition and approval in accordance with the invention.

### DETAILED DESCRIPTION OF EXEMPLARY EMBODIMENTS

The present invention provides an improved system and method for merchant account acquisition, renewal and/or approval. The invention has particular usefulness in the acquisition and/or renewal of merchants for acceptance of transaction cards at merchant locations. Although the system and methods disclosed herein may be suitable for acquisition of various kinds of merchants in a variety of industries, the present invention is conveniently described with reference to the transaction card industry, and more particularly to account acquisitions for acceptance of transaction cards at government-type entities. It should be recognized that the invention has similar application to acquisition, renewal and/or approval of various other types of merchants, such as franchise owners or operators, storefronts, mail orders, phone or home based, e-commerce, and corporate-based clientele. The invention may also be applicable to a contracting system and method for other types of products in addition to financial cards, such as, for example, membership cards, insurance, health care, surveys, events, fundraising, loyalty systems, clubs, trade organizations, unions, lobbying efforts and/or the like.

In one embodiment, the present invention relates to a system that facilitates merchant account approval for acceptance of transactions cards at merchant locations using a cost-effective online channel for merchant acquisition. The invention also includes a cost-effective online channel for merchant account renewal of card acceptance agreements upon, for example, expiration of those agreements. In general, merchants are approved and activated for acceptance of transaction cards with a merchant account and account number in substantially real time. Merchants within the same locale or business (e.g., franchised merchants and state-specific government offices) may be provided with a specific PIN (personal identification number) to permit access to online viewing of that merchant's specific terms and conditions for card acceptance. For example, one or more government entities in a specific state may have already established negotiated terms and conditions for card acceptance for all the government entities in that state. Thus, each government entity of that state can view the agreement specific to that state prior to (or during and/or after) activation of card acceptance, thereby ensuring that each government office of the state receives similar agreement terms and conditions. Other benefits include reduced manpower and costs for acquiring merchant accounts because no or fewer salespeople are involved in the set up and activation of merchants; increased revenues with card acceptance by capturing merchants that salespeople would not normally visit (e.g., remotely located merchants or smaller retail merchants); projected time-savings for merchant account set up by elimination of redundant steps, especially for merchants within the same locale; ease of using an online application, viewing and approval process; and the flexibility for merchants to choose when to apply or renew for card acceptance.

As used herein, the following terms have the meaning defined below or their equivalence:

“Account number” includes any device, code, number, letter, symbol, biometric or other identifier/indicia suitably configured to allow the consumer to interact or communicate with the system, such as, for example, authorization/access code, personal identification number (PIN), Internet code, other identification code, and/or the like which is optionally located on a rewards card, charge card, credit card, debit card, prepaid card, telephone card, smart card, magnetic stripe card, bar code card, transponder, radio frequency card and/or the like. The account number may be distributed and stored in any form of plastic, electronic, magnetic, radio frequency, wireless, audio and/or optical device capable of transmitting or downloading data from itself to a second device. A customer account number may be, for example, a sixteen-digit credit card number, although each credit provider has its own numbering system, such as the fifteen-digit numbering system used by American Express. Each company's credit card numbers comply with that company's standardized format such that the company using a sixteen-digit format will generally use four spaced sets of numbers, as represented by the number “0000 0000 0000 0000”. The first five to seven digits are reserved for processing purposes and identify the issuing bank, card type and etc. In this example, the last sixteenth digit is used as a sum check for the sixteen-digit number. The intermediary eight-to-ten digits are used to uniquely identify the customer. A merchant account number may be, for example, any number or alpha-numeric characters that identifies a particular merchant for purposes of card acceptance, account reconciliation, reporting, or the like.

“Card” includes any suitable device having an associated account, such as, for example, a transaction card, financial card, rewards card, charge card, credit card, debit card, bank card, prepaid card, telephone card, smart card, magnetic stripe card, bar code card, radio frequency card and/or key fob. One skilled in the art will appreciate that a “card” is not limited to a physical device; rather, the card may include an account number associated with an account, wherein the account may be located on the card, associated with the card and/or accessible from a database located remote from the card.

“Merchant” includes any person, entity, business, service establishment, retailer, wholesaler, franchise owner or operator, storefront, mail order company, phone or home based, e-commerce, corporate-based, agency, office, or any other establishment where goods and/or services are sold or provided. “Merchant” also includes government or government-type offices, agencies or entities where the exchange of payment may occur. “Merchant” may also include public service entities such as utility and telephone companies, as well as public schools, libraries, and the like.

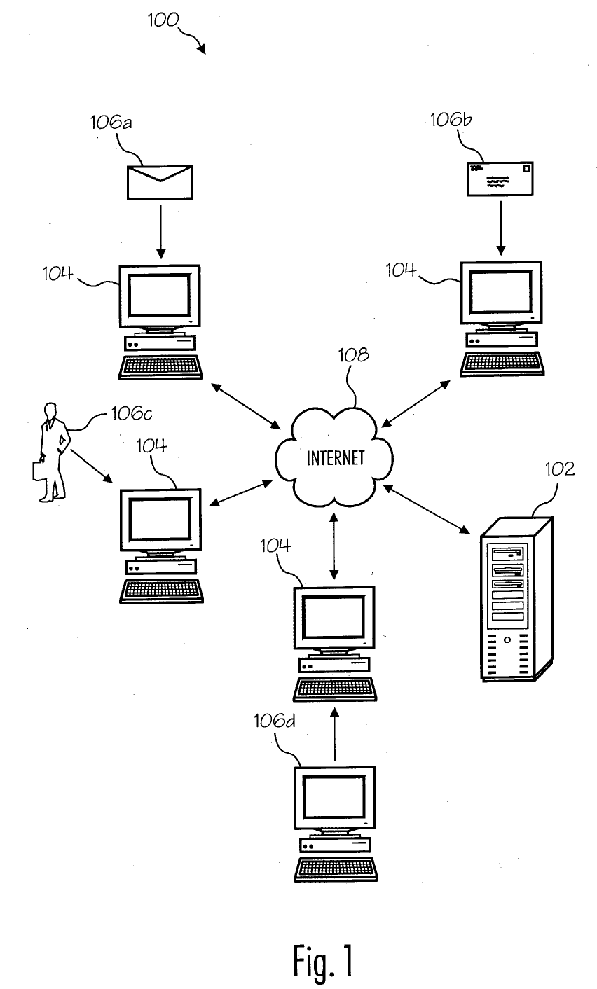

Referring to FIG. 1, a system 100 for merchant account acquisition and approval according to various principles of the invention is shown. System 100 generally includes a host server 102, one or more merchant computing systems 104, an invitation source 106a-106d, and a communication network 108 therebetween.

According to various embodiments, merchants receive an invitation 106a-106d to apply (or renew) for card acceptance at their merchant location(s). For example, the merchant may receive an email or hyperlink 106a; enter a webpage with a link, pop-up ad or banner ad; or a direct mailing 106b from the card issuer inviting them to apply for card acceptance. Additionally, the merchant may be visited by a salesperson 106c or may be referred to apply for card acceptance 106d by an acquaintance, fellow business entity, franchiser, peer agency, and/or the like. Merchants use computing systems 104 to access a website and directly apply for a merchant account via communication network 108 (e.g., the Internet). Host server 102 provides webpages (e.g., HTML (Hyper-Text Markup Language) pages) to computing systems 104 for merchant viewing and entering of information, and receives the completed pages for processing. In one particular embodiment, the merchant is provided a PIN for accessing a predefined set of terms and conditions agreement. The PIN may be provided to the merchant by invitation source 106a-106d or by host server 102. Once all the requested information is received and processed, the merchant is provided with a merchant account number in substantially real time and can almost immediately begin accepting the applied-for card. In most cases, the approval process is substantially transparent to the merchant and occurs in substantially real-time, especially when the merchant is part of a larger merchant locale such as a government entity, whereby the predefined terms and conditions may have already been approved and/or negotiated. Moreover, the approval process occurs in substantially real-time when the default terms and conditions are utilized. Of course, each individual merchant may still have the option to decline predefined, pre-approved or pre-negotiated terms. The foregoing general process will be discussed in further detail in the following flow charts and accompanying descriptions.

Host 102 may include, for example, a processor for processing digital data, a memory coupled to the processor for storing digital data, an input digitizer coupled to the processor for inputting digital data, and an application program stored in the memory and accessible by the processor for directing the processing of digital data by the processor. Host 102 may further include a webservice which receives a request for a browser which includes a URL (universal resource locator) and an IP address. The webservice retrieves the appropriate webpages and sends the webpages to the IP address.

One or more databases may be included in host 102 for storing merchant data, card acceptance agreements, financial institution data and/or like data that can be used in association with the invention. One skilled in the art will also appreciate that, for security reasons, any databases, systems, or components of the present invention may include any combination of databases or components at a single location or at multiple locations, wherein each database or system includes any of various suitable security features, such as firewalls, access codes, encryption, de-encryption and the like.

The database may be any type of database, such as relational, hierarchical, object-oriented, and/or the like. Common database products that may be used to implement the databases include DB2 by IBM (White Plains, N.Y.), any of the database products available from Oracle Corporation (Redwood Shores, Calif.), Microsoft Access by Microsoft Corporation (Redmond, Wash.), or any other database product. The database may be organized in any suitable manner, including as data tables or lookup tables. Association of certain data may be accomplished through any data association technique known and practiced in the art. For example, the association may be accomplished either manually or automatically. Automatic association techniques may include, for example, a database search, a database merge, GREP, AGREP, SQL, and/or the like. The association step may be accomplished by a database merge function, for example, using a “key field” in each of the manufacturer and retailer data tables. A “key field” partitions the database according to the high-level class of objects defined by the key field. For example, a certain class may be designated as a key field in both the first data table and the second data table, and the two data tables may then be merged on the basis of the class data in the key field. In this embodiment, the data corresponding to the key field in each of the merged data tables is preferably the same. However, data tables having similar, though not identical, data in the key fields may also be merged by using AGREP, for example.

Merchant computing systems 104 may include, for example, a computing unit in the form of a personal computer, although other types of computing units may be used including laptops, notebooks, hand held computers, cellular phone, personal digital assistant, set-top boxes, and the like. System 104 generally includes a display and input means, e.g., keyboard, mouse, touch screen, voice recognition software. As those skilled in the art will appreciate, merchant computing system 104 will typically include an operating system (e.g., Windows NT, 95/98/2000, Linux, Solaris, etc.) as well as various conventional support software and drivers typically associated with computers. System 104 can be in a home or business environment with suitable access to a network. In an exemplary embodiment, access is through the internet through a commercially-available web-browser software package.

Communication between the merchant computing system 104 and the host server 102 is accomplished through any suitable communication means for exchanging data or transacting business, such as, for example, a telephone network, intranet, internet, extranet, WAN, LAN, satellite communications, online communications, off-line communications, wireless communications, and/or the like. It is noted that the network may also be implemented as other types of networks, such as an interactive television (ITV) network.

As will be appreciated by one of ordinary skill in the art, a merchant acquisition and approval system in accordance with the various principles of the invention may be embodied as a method, a data processing system, a device for data processing, and/or a computer program product. Accordingly, the invention may take the form of an entirely software embodiment, an entirely hardware embodiment, or an embodiment combining aspects of both software and hardware. Furthermore, the invention may take the form of a computer program product on a computer-readable storage medium having computer-readable program code means embodied in the storage medium.

Any suitable computer-readable storage medium may be utilized, including hard disks, CD-ROM, optical storage devices, magnetic storage devices, and/or the like.

It will be understood that each functional block of the accompanying diagrams and flowchart illustrations can be realized by any number of hardware and/or software components configured to perform the specified functions. For example, the present invention may employ various integrated circuit components, e.g., memory elements, processing elements, logic elements, look-up tables, and the like, which may carry out a variety of functions under the control of one or more microprocessors or other control devices. In addition, the invention may be implemented by computer program instructions. These computer program instructions may be loaded onto a general purpose computer, special purpose computer, or other programmable data processing apparatus to produce a machine, such that the instructions which execute on the computer or other programmable data processing apparatus create means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Software elements may be implemented with any programming or scripting language such as C, C++, Java, COBOL, assembler, PERL, extensible markup language (XML), with the various algorithms being implemented with any combination of data structures, objects, processes, routines or other programming elements.

Further, it should be noted that the present invention may employ any number of conventional techniques for data transmission, signaling, data processing, network control, and the like.

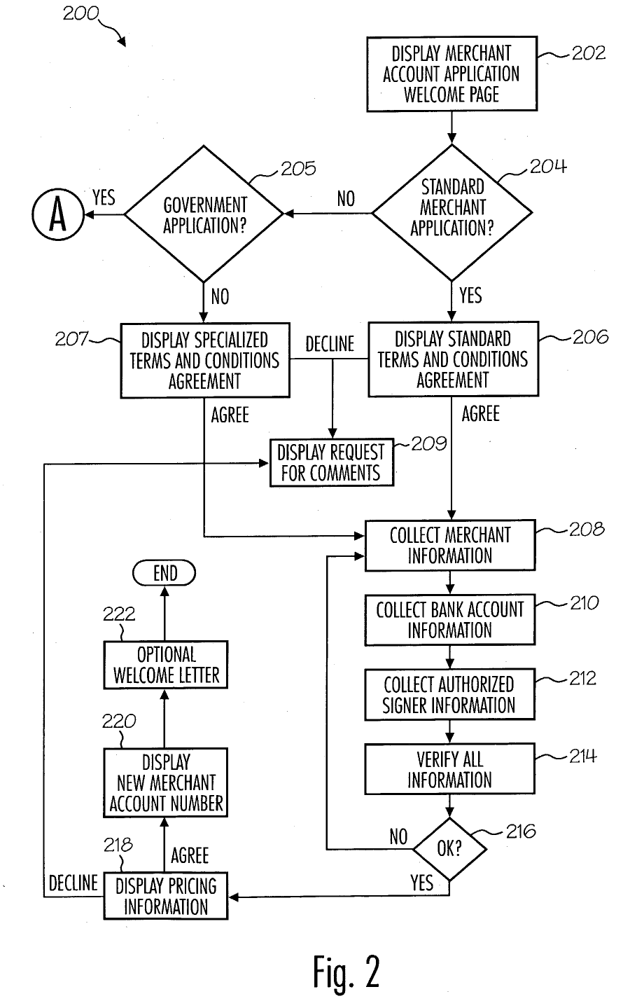

Referring to FIG. 2, a flowchart 200 describing the operation of an exemplary merchant account acquisition and approval system according to an embodiment of the invention is shown. The operation generally begins with the merchant gaining access to, and the system facilitating the display of, a generalized “Merchant Account Application Welcome Page” (step 202). Access may be through any of the previously described techniques and systems such as system 100.

The system may then send a request to the merchant to identify the type of merchant application requested. For example, according to the various principles of the invention, multiple types of merchants can apply for card acceptance and depending on the type of merchant, the terms and conditions of card acceptance may vary. Thus, by identifying what type of merchant is applying for card acceptance, the system can provide the appropriate application and agreement. If the merchant selects a standard merchant application (step 204), then a standard “Terms and Conditions” agreement for card acceptance may be displayed (step 206). If the merchant is not a standard merchant requesting standard card acceptance (e.g., a franchise operator, a government office, a corporate purchasing card application), then a specialized or pre-negotiated terms and conditions agreement for card acceptance may be displayed (step 207). The specialized terms and conditions may include, for example, terms applicable to the type of business structure of the merchant (e.g., franchisee), or may be terms and conditions that have been previously negotiated (e.g., franchise owner).

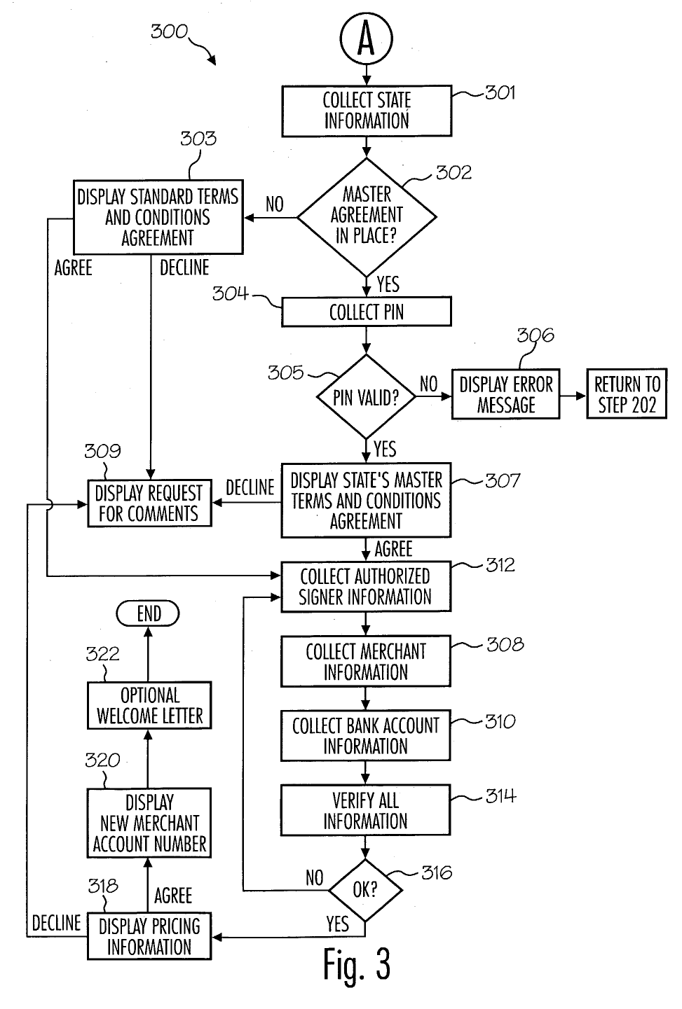

In one particular embodiment, the system may have a specialized application for government-type merchants (step 205). These types of merchants may be, for example, local, city, county, state or federal government departments, agencies or entities. Additional details regarding this type of merchant and application process will follow with respect to FIG. 3 and the accompanying description.

After the terms and conditions agreement is displayed (e.g., steps 206 and 207), the system may request that the merchant accept the agreement by selecting, for example, “Agree” or “Decline.” If the merchant declines the agreement, it may be advantageous to the card issuer to understand why the merchant chose to decline. In this manner, the merchant may be requested to provide feedback or comments on the reasons for declining the agreement (step 209). In the instance where the merchant agrees to the displayed terms and conditions agreement, the process for gathering application information may begin.

Generally, the system requests the merchant to provide information about the business (step 208). For example, the merchant may provide the business or company name and any aliases of the business (i.e., DBA, FKA, AKA), physical location of the business, mailing address of the business, whether the business is home, phone or internet based, contact person information, total sales, average dollar per sale, and any other application-related information which may assist the card issuer in establishing a merchant account number.

The system then requests the merchant to provide bank account information (step 210). This may be, for example, a bank account number, type of account, bank routing number, and/or bank name. This information may be used by the issuer to deposit payments electronically to the merchant's bank account.

The merchant may also be asked to provide authorized signer information (step 212). For example, contact information for an authorized signer of the merchant may be requested to verify that the signer understands and agrees to the application process and/or that the individual agreeing for card acceptance is authorized on behalf of the merchant to do so.

Once a certain portion of the requested information is collected, the merchant may be asked to verify that the information is correct (step 214). The merchant may see a replication of an application having the fields completed with information provided by the merchant. If the merchant chooses to edit any of the information, then the merchant may be brought back to a particular section of the application and asked to input the correct information (step 216). If, however, all the information is accurate, the merchant can proceed through the process and may be shown the pricing information (step 218). The pricing information may include a discount rate that may be deducted from each transaction as payment to the issuer. Moreover, the discount rate may be deducted when some accounts are paid in gross and invoiced for the discount rate. The pricing information may also include a request for authorization of electronic payments into the merchant's bank account. If the merchant agrees to all the pricing terms, the application may be approved and a new merchant account number is generated by the system and displayed to the merchant (step 220). The merchant may be notified that a “Welcome Letter” and/or “Welcome Kit” will be mailed or sent electronically to the merchant (step 222). In an alternative embodiment, to minimize the establishment of fraudulent accounts, the merchant may obtain its merchant (service establishment) number via a link to a secure webpage which allows the merchant to obtain its merchant number and discount rate. In this embodiment, the merchant may not need to complete the application.

As part of any of the methods set forth herein, the system may send a communication to a host in order to allow the host to verify that the data related to merchant or government account is accurate and that the account is appropriately established. In one embodiment, an email which includes the entered application data is sent to a division within the host in order to allow review of the information entered by the merchant/government organization and to verify that, for example, the discount rate and payment parameters offered to the agency are accurate based upon the agency's master agreement. The system may also capture the IP address, browser and local browser time in order to proactively determine if fraudulent set-ups exist. An exemplary email is set forth below:

PROJECT: WTH EMAIL_ID: 72607047
SUBJECT: Govt Agency - State WI, Single Location
CREATE DATE: 3/27/03 10:37:24 PM
STATUS: SENT
EMAIL TO: WTHUSGOVT
EMAIL FROM: americanexpress@mailhub1.com
SE Number[3480196518] Business Namel[sdgfsdgf —VOID]
Doing Business As[co ES Ops Project Team] Business Address1[543
sdgfsdgf] Business Address2 [symbol] Business City[madison] Business State
[WI] Business Zip[53545] Business Phone[53545] Business Fax[53545]
Mailing Address1[543 sdgfsdgf] Mailing Address2 [symbol] Mailing City
[madison]Mailing State[WI] Mailing Zip[53545] Mailing Phone
[608 1650332] Contact Name[gfhgfd sdgfsdg] Email Address
[bruce.fraedrich@aexp.com] URL [symbol] Federal Tax Id[235423543]
SIC Code [symbol] Referring Client [symbol] Total
Revenue[354354] Average Sales[354] Industry[543] Industry
Description[County—Other] DUN's Id [symbol] Account Type[C] Account
Name[sdgfsdgf] Bank Name[sdgsdgf] Bank Address[sdgfsdgf] Bank
City[sdgfsdgf] Bank State[WI] Authorized Signer Name[sdgfsdgf
sdgfsdgf] Authorized Signer Title[sdgfsdgf] Authorized Signer (Years) [0]
Authorized Signer (Months) [0] Discount Rate Offered[2.25]
Internet Browser[Internet Explorer 5.5] User IP Address[12.10.219.30]

Although not mentioned above, it should be recognized to one skilled in the art that each web page may include a “cancel” or “continue” option. For instance, if the merchant is satisfied with the inputs or any pre-set defaults, the “continue” button may be clicked and the next page (i.e., web page) of the application is displayed. If, however, the merchant chooses to cancel the application at any point in the process, the merchant can select the “cancel” button and stop the process. By canceling the application, the merchant may be asked to provided feedback to the issuer indicating why there was a cancellation of application (similar to step 209).

Referring now to FIG. 3, a flowchart 300 describing an exemplary operation of a government merchant account acquisition and approval system according to another embodiment of the invention is shown. In the event the merchant indicates that it is a government entity, the merchant may be asked to provide the state in which the entity is located (step 301). Alternatively, the system may already have access to the state information from the invitation source. For example, depending on the type of invitation, the issuer may include a code number or electronic indicator to identify government entities from a particular state. If the state has already agreed upon certain terms and conditions for card acceptance, the issuer may have a Master Agreement in place for that state (step 302). In other words, the card issuer may negotiate certain terms and conditions with the state and hence all the government entities, agencies, etc. from that state can receive the same negotiated terms. By using a master agreement, the state receives the benefit of the master discount rate and, by linking the different entities, the system facilitates reporting such as, for example, charge volume and transactions for each entity at the state level. If, however, the card issuer does not have a Master Agreement in place for the state, then a standard terms and conditions agreement may be displayed (step 303).

In one particular embodiment, a state-specific PIN (personal-identification-number) or the equivalent is set up. Different PINs may be assigned to each state or any other grouping of entities. The PIN may be provided to the merchant by the invitation source or some other means discussed herein or known in the art. In another embodiment, PINs may only be assigned to states that have a Master Agreement in place. In either embodiment, the system requests the merchant to provide the PIN (step 304) during the application process. If the merchant does not have a PIN or cannot locate the PIN, the merchant may be asked to telephone or email the card issuer to obtain the PIN. The PIN helps to ensure that only authorized users gain access to the state's Master Agreement. If the PIN entered is not recognized by the system as a valid number (step 305), then an error message may be displayed (step 306) and the merchant can be returned to a previous page (e.g., the Welcome Page (step 202)).

In another embodiment, a PIN may be used to further identify a specific state, for example a string of digits or single digit may be used to indicate a particular state. The PIN may also be used to inform the issuer how the merchant received an invitation to apply. For example, the PIN may include a string of digits or single digit to indicate the number came from a single source (i.e., a batch of PINs provided to a single entity), by direct mail, by a salesperson, or by email.

In yet another embodiment, the PIN may be used to indicate a specific discount rate previously agreed upon. Additionally, the system may include an incentive program such as, for example, the more merchants which sign up for card acceptance under a specific PIN or locale, the lower the discount rate. For example, a state may have negotiated a certain discount rate for all the state agencies under its jurisdiction which sign up. If, however, more than a set number of agencies sign up, then the discount rate is reduced. The PIN may also be used as a tracking identifier for the issuer to tally the number of agencies signed up.

Upon acceptance of a valid PIN, the state's Master Agreement or terms and conditions is displayed for the merchant (step 307). The Agreement may be displayed by requesting that the merchant download the Agreement for viewing on the merchant's terminal, or the Agreement may appear as a separate page, click-on page or scroll down page. Additional terms may also appear as part of a download or by a scroll down menu. The system requests the merchant to review the terms and conditions and then provide an input, e.g., select “Agree” or “Decline.” If the merchant declines the terms and conditions (regardless of which terms and conditions the merchant is viewing, i.e., standard or master)), the merchant may be asked to provide the card issuer with feedback indicating the reasons for decline (step 309).

If the merchant agrees to the terms and conditions, then the system requests the merchant to provide information needed to complete the application process. For example, authorized signer information (step 312), merchant information (step 308), and bank account information (step 310). This information may include any relevant information needed to process an application for card acceptance, including the previously described items for similar steps 208, 210, 212. The merchant may be asked to verify all the information is correct (step 314) and edit any incorrect entries. If the information is accurate, the merchant may be asked to review the pricing information (step 318). Again, similar to previously described steps 218, 220, 222, the merchant may be asked to “Agree” with the pricing terms or provide reasons for declining. A new merchant account number is provided to the merchant (step 320) upon approval of the application, and an optional “Welcome Lefter” may be sent (step 322).

Thus, in accordance with the present invention, a system and method for merchant account acquisition and approval uses a “real time” account set-up process which permits the merchant to begin card acceptance almost immediately upon receipt of a merchant account number. In addition, the online system for merchant account acquisition and approval is easily assessable to almost all merchants, regardless of their size or locale, and provides a secure way to set-up merchants of a targeted group with the same terms and conditions.

It should be appreciated that the particular implementations shown and described herein are illustrative of the invention and its best mode and are not intended to otherwise limit the scope of the present invention in any way. Those skilled in the art having read this disclosure will recognize that changes and modifications may be made to the embodiments without departing from the scope of the present invention. For example, while conveniently described in connection with the financial card industry, the present invention is not so limited. Rather, a variety of industries desiring an improved approach to membership acquisition may benefit from the system and methods of the present invention as expressed in the claims. Benefits, other advantages, and solutions to problems have been described above with regard to specific embodiments. However, the benefits, advantages, solutions to problems, and any element(s) that may cause any benefit, advantage, or solution to occur or become more pronounced are not to be construed as critical, required, or essential features or elements of any or all the claims. As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus. Further, no element described herein is required for the practice of the invention unless expressly described as “essential” or “critical”.

1. A merchant account approval system configured for facilitating approval of merchant accounts, the system comprising:
a webservice coupled to a server, said webservice having a website which includes a plurality of web pages comprising a merchant account application; and
a merchant workstation in communication with said website via a network, said workstation having an input device configured for completing said merchant account application, and a display for viewing a merchant account application retrieved from said server and for viewing a conditional statement retrieved from said server;
said conditional statement comprising at least one of a set of default terms and a specific set of terms, wherein a selection of said conditional statement being dependent upon the type of merchant applying for account approval;
whereby said server receives said application from said workstation, generates a merchant account number and provides said account number to said workstation via said network in substantially real-time upon receiving said application.

2. The system of claim 1, wherein said merchant comprises a government entity.

3. The system of claim 1, wherein said selection of the conditional statement corresponds to a personal identification number (PIN) input at said merchant workstation.

4. The system of claim 1, further comprising a welcome email sent to said merchant workstation upon approval of said merchant account application.

5. The system of claim 1, further comprising an invitation source to apply for card acceptance.

6. The system of claim 1, wherein said approval system includes an approval system configured for facilitating at least one of approval of a new merchant account and renewing an existing merchant account.

7. A method for facilitating merchant transactional card account acceptance, the method comprising:
(a) accessing an Internet website from a merchant workstation, said website linked to a server having a merchant account application for card acceptance stored thereon;
(b) displaying said merchant account application;
(c) receiving requested field information on said application;
(d) receiving a PIN to access a specific set of terms and conditions for card acceptance;
(e) displaying said set of terms and conditions for card acceptance, said set provided to said merchant workstation for viewing based upon said PIN and a type of merchant;
(f) submitting said application for approval; and
(g) receiving a new merchant account number for immediate card acceptance.

8. The method of claim 7, further comprising receiving an invitation to apply for card acceptance.

9. The method of claim 8, wherein said invitation comprises at least one of an email, a hyperlink, and a direct mailing.

10. The method of claim 8, wherein said invitation includes said PIN.

11. The method of claim 7, further comprising receiving a welcome kit via email.

12. The method of claim 7, wherein said type of merchant comprises a government entity.

13. The method of claim 8, wherein said PIN identifies a source of said invitation.

14. The method of claim 7, wherein said PIN includes a tally identifier to count the number of merchants signed up for said account.

15. An online method for acquisition of merchant transactional card account acceptance, said method comprising:
(a) retrieving a merchant account application from a server having an application website stored thereon;
(b) displaying said application on a merchant workstation;
(c) receiving a data input from said merchant workstation and analyzing said input to determine a type of merchant;
(d) retrieving a conditional statement from said server, said conditional statement comprising a set of terms and conditions and corresponding to said type of merchant;
(e) receiving a response to said conditional statement;
(f) if said response is positive, then accepting said application to begin an approval process, and if said response is negative, then declining said application; and
(g) providing a merchant account number for immediate use upon acceptance of said application.
